(19) United States
(12) Patent Application Publication
(10) Pub. No.: US 2006/0153316 A1
(43) Pub. Date: Jul. 13, 2006

(54) Fsk receiver having a variable threshold slicer stage and corresponding method

(75) Inventors: Adrian W. Payne, Horley (GB); Richard J. Caldwell, Reigate (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,260

(22) PCT Filed: Jul. 8, 2003
(86) PCT No.: PCT/IB03/03028

§ 371 Date: Jan. 13, 2005

(30) Foreign Application Priority Data
Jul. 18, 2002 (GB) 02167039

(51) Int. Cl. H04L 27/14

(52) U.S. Cl. 375/334

(57) ABSTRACT

A receiver having a variable threshold slicer stage, comprises a demodulator (14) for providing asynchronously samples of over-sampled raw demodulated data, a shift register (60) for delaying the over-sampled data by up to 2 bit periods. Samples in stages (62, 72) corresponding to substantially the mid-points in two successive bit periods are combined to form a signal (fXₙ) to be applied to a bit slicer (22). A bit stream signal from the bit slicer (22) is delayed by two concatenated shift registers (30,32) for 2 bit periods and is contemporaneously applied to a clock recovery circuit (74) for producing clock signals at the data rate for sampling the delayed sliced signal (Bn-2) at the center of bit to produce an output signal (34).

The present invention relates to a receiver having a variable threshold slicer stage. The present invention has particular, but not exclusive, application to FSK receivers such as may be used in accordance with the Bluetooth standard.

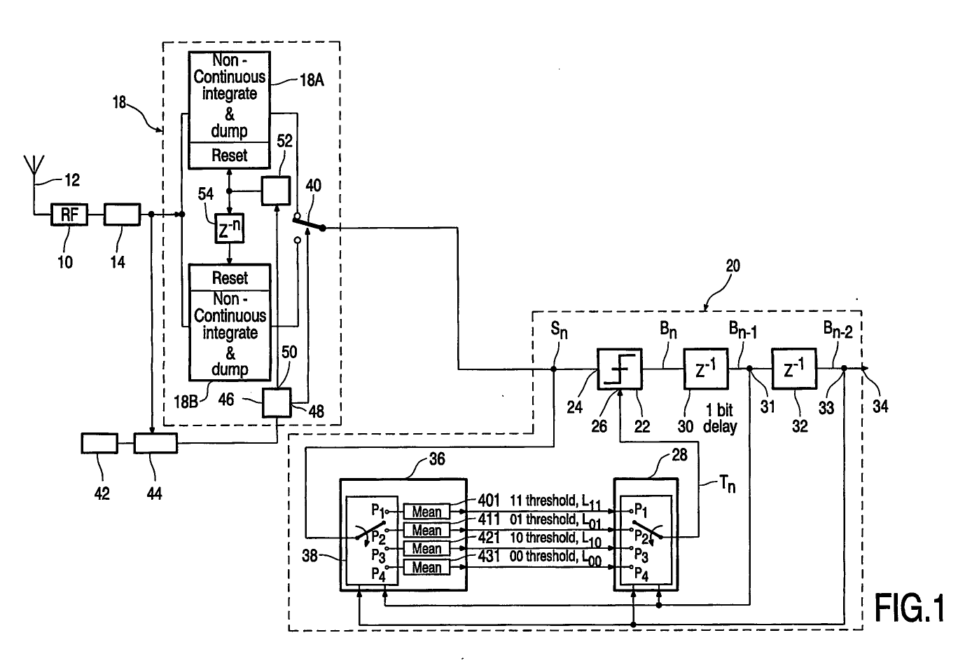

Unpublished PCT patent application IB01/02707 (Applicant's reference PHGB 010002) relates to such a receiver. FIG. 1 of the accompanying drawings shows a simplified block schematic diagram of a GFSK receiver having a variable threshold slicer as disclosed in this prior patent application. The GFSK receiver comprises a rf front end 10 having an input coupled to an antenna 12 and an output coupled to a demodulator 14 which may be digital or analogue depending on the architecture of the receiver. An integrate and dump stage 18 is coupled to an output of the data filter 16 and to an input of a variable threshold slicer 20 which has an output 34 for the detected bits.

The integrate and dump stage 18 comprises two alternately reset integrate and dump stages 18A, 18B which are able to provide a signal every bit period, which signal is based on the digital signal values over the two preceding bit periods. A switch 40 is toggled every bit period to connect alternately the outputs of the stages 18A, 18B to the input 24 of the slicer 22.

A master clock 42 provides a clock signal having a frequency which is a multiple of the bit rate. Timing synchronisation of the clock signal with the output of the demodulator 14 is effected in a synchronising stage 44. The stage 44 is coupled to a toggle every bit stage 46 having a first output 48 coupled to the switch 40 and a second output 50 coupled to a reset every 2 bits stage 52. The stage 52 is coupled firstly to a reset input of the integrate and dump stage 18A and secondly to a one bit delay stage 54 whose output is coupled to a reset input of the integrate and dump stage 18B. The provision of the delay stage 54 enables the stages 18A and 18B to be alternately reset every bit period.

The variable threshold slicer 20 comprises a slicer or comparator 22 having a first input 24 for a signal Sₙ from the integrate and dump stage 18 and a second input 26 for one of four threshold levels as selected by a threshold level selector 28 implemented as a four position switch having positions P₁ to P₄. An output of the slicer 22 is coupled to two series connected one bit delay stages 30, 32, an output 33 of the latter being connected to the output terminal 34. The bit Bₙ on the output of the slicer 22 represents the current bit, and the bits Bₙ₋₁ and Bₙ₋₂ on outputs 31, 33, respectively, are the two immediately preceding bits delayed by one bit and two bit intervals, respectively. The values of these two immediately preceding bits Bₙ₋₁, Bₙ₋₂ are used to select the particular threshold level Tₙ to be applied to the input 26 of the slicer 22. The following truth table indicates how the binary values of Bₙ₋₁, Bₙ₋₂ determine the position of the level selector 28.

| Bₙ₋₂ | Bₙ₋₁ | Switch Position |
|---|---|---|
| 1 | 1 | P₁ |
| 0 | 1 | P₂ |
| 1 | 0 | P₃ |
| 0 | 0 | P₄ |

Thus the values of the two bits preceding the current bit Bₙ determine the present threshold level.

The values of the threshold levels are provided by a threshold estimating stage 36. The stage 36 comprises a four position threshold selector switch 38 comprising, for convenience of reference, positions P₁ to P₄ which correspond to the threshold positions of the selector 28. The input signal to the switch 38 comprises the signal Sₙ from the integrate and dump stage 18. Long time constant integrators 401, 411, 421 and 431 having a time constant of the order of, or greater than, one thousand bits to reduce the effects of noise are connected respectively between positions P₁-P_{1,} P₂-P_{2,} P₃-P_{3,} P₄-P₄ of the stages 36 and 28 to provide the four mean threshold levels L_{11,} L_{01,} L_{10,} L_{00,} respectively. The position determined by the switch 38 is also selected by the values of the bits B_{n-2,} and B_{n-1,} Thus the threshold level being applied to the input 26 of the slicer 22 is also the level which is being updated by the signal Sₙ.

ISI (Intersymbol Interference) causes the current bit Bₙ to be affected by adjacent bits. For GMSK modulation with a BT of 0.5, the previous bit Bₙ₋₁ is dominant, Bₙ₋₂ has some effect and Bₙ₋₃ has very little effect. For each bit decision, a slicer threshold is chosen that is positive if the net effect of the ISI caused by the previous sequence of bits produces a positive bias and is negative if there is a negative bias. In FIG. 1, only the last two preceding bits Bₙ₋₁ and Bₙ₋₂ are needed to choose thresholds with sufficient resolution. The slicer 20 chooses a threshold according to the history of the previous two bits, that is, whether the last two detected bits were 11, 01, 10 or 00. Thus each bit decision requires the selection of one of only four thresholds.

The output of the digital demodulator 14 is a time-discrete waveform with an amplitude representing the GFSK modulated data. In practice the demodulated signal is sampled at, say, 20 times the data rate, and each bit will be overspread to adjacent bits due to ISI. To analyse this information, an integration function is used that produces an estimate of the change in phase dominated by that caused by the latest bits. The integrate and dump stage 18 has a hold function, whereby the output of an integrator is held at the end of a period of two bits and is then reset.

The signal which is sliced is the demodulated signal which has been integrated and held over the last few bits. In doing this the integration must be performed over a specific portion of the signal and must therefore be synchronised with the demodulated signal. As timing synchronisation will not be achieved initially it is not possible to use such a variable threshold slicer and the demodulated signal is first sliced with a conventional slicer and the sliced data used to drive a digital phase lock loop in order to achieve timing synchronisation before the integrators used in the variable threshold slicer can be started. It is desired to avoid this delay in enabling the variable threshold slicer to become effective.

An object of the present invention is enable a variable threshold slicer to be able operate freely without prior synchronisation.

According to one aspect of the present invention there is provided a method of determining the values of data bits from a demodulated frequency shift key signal, comprising over-sampling raw data recovered from a demodulated signal, delaying samples of the raw data, combining selected delayed samples of the raw data to form a sample to be bit sliced, bit slicing the samples to be sliced to produce a bit stream signal, delaying the bit stream signal, using the bit stream signal to recover a clock signal, and using the recovered clock signal to sample the delayed bit stream signal at the data rate to produce detected bits.

According to a second aspect of the present invention there is provided a receiver for use with FSK signals, comprising a demodulator for supplying over-sampled raw data, first delay means for delaying the over-sampled raw data, means for combining selected delayed samples of the raw data to provide samples to be sliced, bit slicing means for producing a bit stream signal from the samples to be sliced, second delay means for delaying the bit stream signal, clock recovery means coupled to the bit slicing means and bit sampling means coupled to an output of the second delay means and controllable by the clock recovery means to produce detected bits.

The present invention will now be described, by way of example with reference to the accompanying drawings, wherein:

FIG. 1 is a block schematic diagram of a GMSK receiver having of the type disclosed in PCT patent application IB01/02707, and

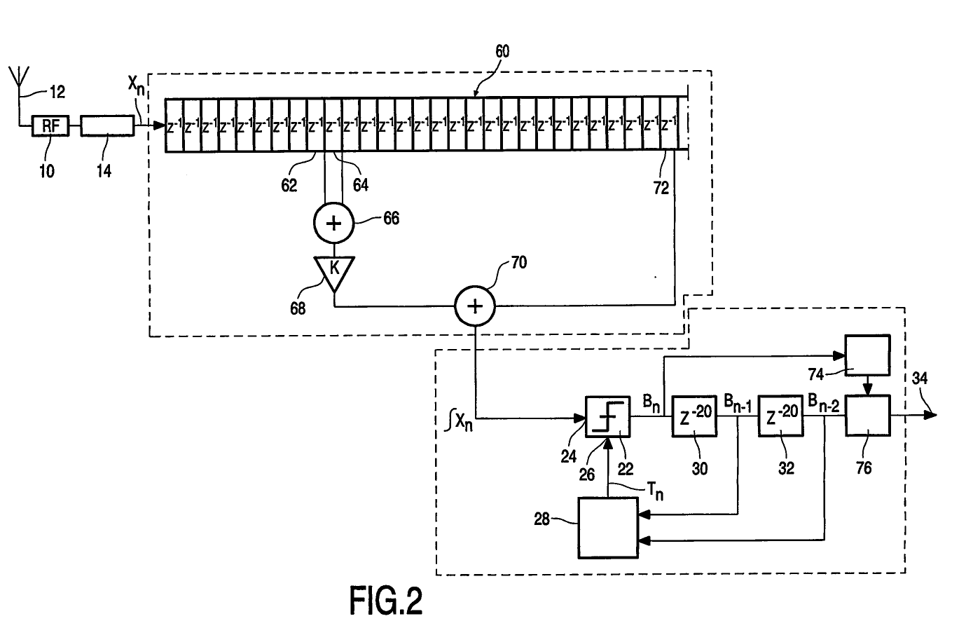

FIG. 2 is a block schematic diagram of an embodiment of a receiver made in accordance with the present invention.

In the drawings the same reference numerals have been used to indicate corresponding features.

Referring now to FIG. 2 of the accompanying drawings, in the interests of brevity only the differences between the illustrated embodiment and the known embodiment of FIG. 1 will be described.

The signal Xₙ from the demodulator 14 is over-sampled in the illustrated embodiment by a factor of 20 times the bit rate. An over-sampling factor of 20 is not intended to be limiting and factors having a lower or higher value could be used as well as other ways to vary the factor for example by adding other samples. The over-sampled signal is applied to a delay line comprising a shift register 60 having at least 29 stages and which can delay the signal applied to its input by 29 sample periods (or 1.5 bit periods). Outputs are derived from the 9^{th} and 10^{th} stages 62, 64, corresponding to a time delay of substantially half a bit period, and are added together in an adder 66. The sum is applied to an amplifier 68 which it is multiplied by a gain factor K. An output of the amplifier 68 is applied to a first input of an adder 70.

An output is derived from the 29^{th} shift register stage 72, which corresponds to a delay of substantially one and half bit periods, and is applied to a second input of the adder 70. An output corresponding to an approximation ∫Xₙ is applied to the input 24 of the bit slicer 22 to generate a bit stream. An output of the bit slicer 22 is applied to two cascaded shift registers 30, 32 and to a clock recovery circuit 74. In the illustrated embodiment the shift registers 30, 32 have 20 stages but a different number of stages could be used provided each of the shift registers has an overall delay of one bit period. The clock recovery circuit 74, which may comprise a digital phase locked loop (DPLL), controls a sampling circuit 76 having an input coupled to an output of the second shift register 32 and an output coupled to the output 34 for the detected bits.

In operation the two cascaded shift registers 30, 32 provide the history of the previous two bits Bₙ₋₁, Bₙ₋₂ which is used for the selection of the slice level and for the adjustment of this slice level. These bits Bₙ₋₁, Bₙ₋₂ are fed back to the threshold circuit 28 without being synchronized to the data rate. The clock recovery circuit 74 is used to sample the output of the second shift register 32 in the middle of the bit at the data rate and provide a sequence of bits on the output 34.

If it is desired to use the previous bit Bₙ₋₃ then a further shift register would be cascaded with the shift registers 30, 32. A three bit signal will then be used to select the threshold level Tₙ.

In order to reduce the inaccuracy of the raw sliced data Bₙ, the following function can be performed:
B′ₙ=Lim(Bₙ+Z⁻¹·Bₙ+Z⁻²·Bₙ)
where Z⁻¹ and Z⁻² are the delays due to the shift registers 30, 32.

Adding three samples and re-slicing removes single-sample oscillations which are most likely to occur when the signal is being sliced at near to the zero crossings. As the mean delay through this function is one sample period, the first bit delay should be reduced by one sample. This averaging should improve the threshold decision process and the clock recovery settling time.

The gain factor K is applied to the two most recent samples, that is the 9^{th} and 10^{th} samples present in the stages 62, 64. This alters the integration function, biasing the effect of the last bit relative to the previous bit. This function is already biased twice by having twice samples from the most recent bit, that is as the shift register 60 is clocked, the 9^{th} sample in the stage 62 becomes the 10^{th} sample in the stage 64, and thereby contributes in two successive sampling periods to the sum formed in the stage 66. This was done because simulations of the circuit showed that this gave the best trade-off between sensitivity and co-channel rejection. Also these simulations suggested that an optimum value for K would be close to 1. By reducing K from 1 to 0.8, the simulations showed that there can be made a slight improvement in sensitivity of about 0.2 dB. It has been found that by choosing K=2 is significantly worse, which would be similar to using two samples from each bit.

In summary during the start-up phase of the receiver circuit the demodulated output is asynchronously over-sampled and selected raw data samples are combined to form an input signal to the slicer 22. The output Bₙ from the slicer 22 is applied to the clock recovery circuit 74 which synchronizes the sampling of the recovered data signal to the data rate. Once the clock recovery circuit 74 has synchronized, the bits Bₙ₋₁, Bₙ₋₂ fedback could be synchronized data. Thereafter the variable threshold circuit 22 will function in accordance with the embodiment as described in FIG. 1 of the accompanying drawings or the embodiments described in unpublished PCT patent application IB01/02707 (Applicant's reference PHGB 010002).

The variable threshold slicer shown in FIG. 2 is both simpler to implement as well as to operate compared to the circuit shown in FIG. 1. Also a separate, conventional slicer is not required for clock recovery, the clock recovery does not have to be done with a fast DPLL (Digital Phase locked Loop) and the overall circuit itself is simpler.

In order to enhance the performance of variable threshold slicers in situations where delay spread due to multipath can cause loss of signal at one deviation of a FSK signal, it has been found beneficial to normalise the amplitude of the signal at the input to the variable threshold slicer in order to achieve optimum bit error rate (BER) when this kind of delay spread occurs. The normalisation may be effected using a circuit which approximates to a 1-tap equaliser. In operation, the gain normalisation can be achieved using the maximum peak-to-peak amplitude value of the signal occurring say during the sync. code word as a reference.

The numerical values given in the description of the embodiment shown in FIG. 2 are illustrative and are not intended to be limiting.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use receivers having variable threshold slicer and component parts therefor and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of determining the values of data bits from a demodulated frequency shift key signal, comprising over-sampling raw data recovered from the demodulated signal, delaying samples of the raw data, combining selected delayed samples of the raw data to form a sample to be bit sliced, bit slicing the samples to be sliced to produce a bit stream signal, delaying the bit stream signal, using the bit stream signal to recover a clock signal, and using the recovered clock signal to sample the delayed bit stream signal at the data rate to produce detected bits.

2. A method as claimed in claim 1, characterised in that samples of the delayed raw data occurring after a delays of substantially half a bit period and one and a half bit periods are combined to form samples to be bit sliced.

3. A method as claimed in claim 1, characterised in that at least two successive samples of the raw data occurring after a delay of substantially half a bit period are added and multiplied by a gain factor and the result is added to at least one sample of raw data occurring after a delay of substantially one and a half bit periods.

4. A method as claimed in claim 3, characterised in that the gain factor has a value of substantially unity.

5. A method as claimed in any one of claims 1 to 4, characterised by normalising the sample to be sliced prior to bit slicing.

6. A receiver for use with FSK signals, comprising a demodulator (14) for supplying over-sampled raw data, first delay means (60) for delaying the over-sampled raw data, means (66, 68, 70) for combining selected delayed samples of the raw data to provide samples to be sliced, bit slicing means (22) for producing a bit stream signal from the samples to be sliced, second delay means (30, 32) for delaying the bit stream signal, clock recovery means (74) coupled to the bit slicing means (22) and bit sampling means coupled to an output of the second delay means (30, 32) and controllable by the clock recovery means (74) to produce detected bits.

7. A receiver as claimed in claim 6, characterised in that the first delay means (60) comprises shift register means having at least 3N/2 stages, where N is the number of stages corresponding to the over-sampling ratio, and in that outputs from, or in the vicinity of, stages N/2 and 3N/2 are applied to the combining means (66, 68, 70).

8. A receiver as claimed in claim 6, characterised in that the first delay means (60) comprises shift register means having 3N/2 stages, where N is the number of stages corresponding to the over-sampling ratio, and in that the combining means (66, 68, 70) comprises a first adding stage coupled to outputs of two adjacent shift register stages in the vicinity of stage N/2, a scaling stage coupled to an output of the first adding stage, a second adding stage having a first input coupled to an output of the scaling stage, a second input coupled to output of a shift register at, or in the vicinity of, the stage 3N/2 and an output coupled to the bit slicing means (22).

9. A receiver as claimed in claim 8, characterised in that the scaling stage has a scaling factor of substantially unity.

10. A receiver as claimed in claim 7, 8 or 9, characterised in that the over-sampling ratio equals 20, in that outputs of stages 9, 10 and 29 are applied to the combining means (66, 68, 70).

11. A receiver as claimed in any one of claims 6 to 10, characterised in that the second delay means (30, 32) comprises first and second delay stages, each having a delay of substantially one bit period, in that the bit slicing means has means for storing a plurality of threshold values, and means for selecting a threshold value for comparison with the currently held samples to be sliced in dependence on the bit values at outputs of the first and second delay stages.
